(19) United States
(12) Patent Application Publication
(10) Pub. No.: US 2021/0264486 A1
(43) Pub. Date: Aug. 26, 2021

(54) Methods For Imposing Accountability In An Online Community Exchange System

(71) Applicant: Wensheng Vincent Kuang, Valencia, CA (US)

(72) Inventor: Wensheng Vincent Kuang, Valencia, CA (US)

(21) Appl. No.: 16/798,352

(22) Filed: Feb. 22, 2020

(51) Int. Cl. G06Q 30/06; G06Q 30/02; G06Q 30/08

(52) U.S. Cl. CPC G06Q 30/0605; G06Q 30/08; G06Q 30/0208; G06Q 30/0213

(57) ABSTRACT

A penalty fee is charged in an online community exchange system to users for failing to carry out exchange agreements; the penalty fee is set as a fraction of the price of the exchange agreements, or a fixed amount, or a combination of both. Two debt limits, a maximum limit and a transaction-based limit, are set and imposed on all users in the online community exchange system. The transaction-based debt limit is set individually for each user, based on any of the three accumulated transaction data: accumulated credit transaction, accumulated debit transaction, or accumulated credit & debit transaction, in each user's exchange account. A user needs to satisfy both the two debt limits in order to continue to buy goods and services in the exchange system.

### FIELD OF THE INVENTION

This invention relates generally to an online community exchange system without the use of national currencies, and particularly to imposing accountability in the online community exchange system.

### BACKGROUND OF THE INVENTION

Electronic commerce (e-commerce) and online marketplace using national currencies such as the United States dollar make exchange of goods and services easy and efficient. It may be beneficial to the national and/or global economy; however, it may not always be beneficial to local economies. On the other hand, exchange of goods and services in an online local community marketplace without using national currencies can be beneficial to local economies. With the use of local currencies such as a local digital currency, the online community marketplace creates and keeps wealth in the community.

There are a few local community exchange systems or platforms that have been trialed around the world, for example, local exchange trading system (LETS), mutual credit trading systems, clearing circles, and time banks. They all use local currencies, as opposed to national currencies used in conventional value exchange. A community exchange system can be an online trading platform which allows participants to buy and sell goods and services using a local digital currency. The community exchanges could help build real wealth in a community, fostering self-reliance & self-esteem, fostering social justice & equality, keeping wealth where it is created and fostering a sense of community.

However, without the use of national currencies, the online community exchange system operates more like a community information service, recording transactions of users exchanging goods and services. Like in any other system with human beings involved, lack of accountability and abuse of the system occur, which hinder the effectiveness and growth of the online community exchange system and keep it from contributing more to the community and its economy.

Present invention gives methods of imposing accountability in the online community exchange system or platform, improving efficiency and effectiveness of the online community exchange system.

### SUMMARY OF THE INVENTION

In accordance with the present invention, two methods are disclosed to impose or improve accountability in an online community exchange system or platform. One is to impose a penalty fee for failing to carry out exchange agreements in the online community exchange system. The penalty fee is set as a fraction of the price of the exchange agreements, or a fixed amount of points, or a combination of both. The other method is to impose two debt limits, a maximum limit and a transaction-based limit, on all users in the online community exchange system. The transaction-based debt limit is set individually for each user, based on any of the three accumulated transaction data: accumulated credit transaction, accumulated debit transaction, or accumulated credit & debit transaction, in each user's exchange account. A user needs to satisfy both the two debt limits in order to continue to do debit transaction, i.e. to buy goods and services, in the exchange system.

Other objectives and further advantages and benefits associated with this invention will be apparent to those skilled in the art from the description, examples, and claims that follow.

### BRIEF DESCRIPTION OF THE DRAWINGS

Preferred forms of the invention are described with reference to the accompanying drawings.

FIG. 1 illustrates a network diagram of an example system that can be utilized as an online community exchange system, according to an embodiment of the present invention.

FIG. 2 is a tabular illustration of user account database according to an embodiment of the present invention.

FIG. 3 is a tabular illustration of exchange agreement database according to an embodiment of the present invention.

FIG. 4 is a tabular illustration of actual transaction database and a penalty fee imposed to a user for failing to carry out an exchange agreement according to an embodiment of the present invention.

FIG. 5 is another tabular illustration of actual transaction database and a penalty fee imposed to a user for failing to carry out an exchange agreement according to an embodiment of the present invention.

FIG. 6 is yet another tabular illustration of actual transaction database and a penalty fee imposed to a user for failing to carry out an exchange agreement according to an embodiment of the present invention.

FIG. 7 is a tabular illustration of imposing the two debt limits in the online community exchange system according to an embodiment of the present invention.

FIG. 8 is another tabular illustration of imposing the two debt limits in the online community exchange system according to an embodiment of the present invention.

FIG. 9 is yet another tabular illustration of imposing the two debt limits in the online community exchange system according to an embodiment of the present invention.

FIG. 10 is yet another tabular illustration of imposing the two debt limits in the online community exchange system according to an embodiment of the present invention.

The figures depict various embodiments of the disclosed methods for purposes of illustration only, wherein the figures use like reference numerals to identify like elements. One skilled in the art will recognize from the following discussion that alternative embodiments of the methods illustrated in the figures can be employed without departing from the principles of the disclosed methods described herein.

### DETAILED DESCRIPTION OF THE INVENTION

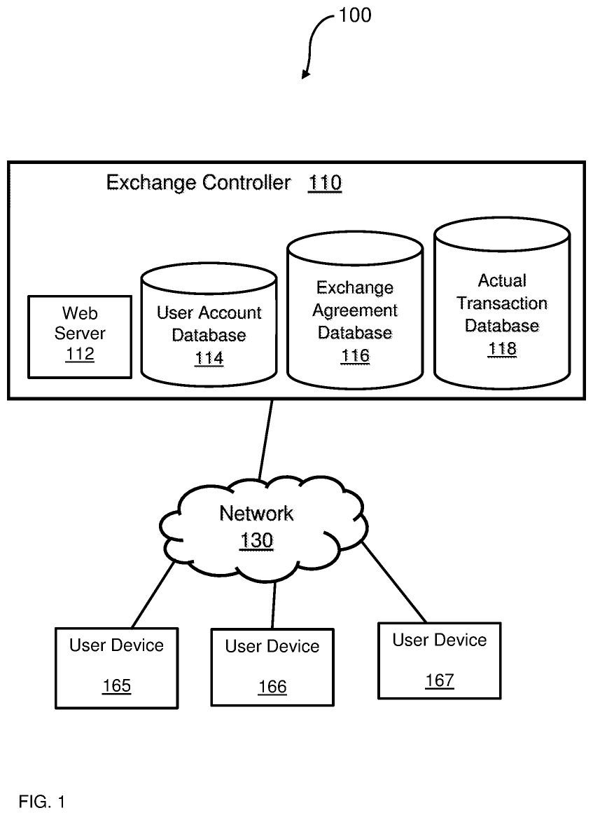

FIG. 1 illustrates a network diagram of an online community exchange system 100 according to an embodiment of the present invention. The system 100 includes an exchange controller 110 that is in communication with user devices 165, 166, and 167 via a network 130, via another network protocol, or via other means for communication as would be understood by those skilled in the art. Although three user devices 165, 166, and 167 are depicted in FIG. 1, any number of user devices may be in communication with the exchange controller 110. The network 130 may comprise any combination of local area and/or wide area networks, using wired and/or wireless communication systems.

The user devices 165, 166, and 167 may comprise computing devices or mobile phones that are adapted to communicate with the exchange controller 110 via the network 130. And the users of the devices 165, 166, and 167 also can communicate and interact with each other via the network 130 and the exchange controller 110. Those skilled in the art will understand that the users in communication with each other need not be continually communicating to each other. On the contrary, they need only communicate to each other as necessary.

In addition to establishing and maintaining connections between users and allowing interactions between users, the community exchange controller 110 provides users with the ability to buy or sell goods and services with each other in the community exchange system 100. The exchange of goods and services between the users in the system 100 is conducted without using national currencies such as the United States dollar, instead, local community currencies such as a local digital currency are used to facilitate the exchange.

The exchange controller 110 includes a web server 112, a user account database 114, an exchange agreement database 116, and an actual transaction database 118. In an embodiment of the invention, the exchange controller 110 may include additional or different components for various applications. Other components, such as processors, network interfaces, security mechanisms, failover servers, management and network operations consoles, and the like are omitted here for clarity.

The web server 112 links the exchange controller 110 to the user devices 165, 166, and 167 via the network 130. The web server 112 serves web pages, as well as other web-related content. It may include a mail server or other messaging functionality for receiving and routing messages between the exchange controller 110 and the user devices 165, 166, and 167. The messages can be instant messages, queued messages (e.g., email), text and SMS messages, or any other suitable messaging format.

The user account database 114 maintains information about the users' exchange accounts, including name, phone number, address, account balance and transaction data from the users' exchange activities, and other types of descriptive information.

The exchange agreement database 116 stores buy and sell exchange agreements between the users for exchanging goods and services in the online community exchange system 100, including description of agreements, pricing information, transaction time, and other types of descriptive information.

The actual transaction database 118 stores information about how exchange agreements are carried out, whether a penalty fee is charged to a user who fails to carry out an exchange agreement, and final amount of credit or debit points exchanged in the transaction.

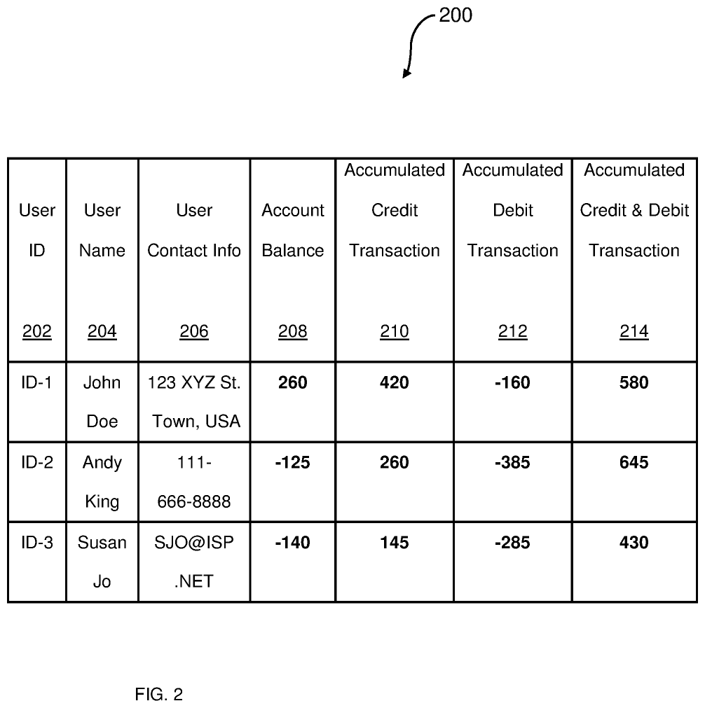

Referring to FIG. 2, as an example of the user account database 114, a tabular user account data 200 is illustrated. The user ID field 202 stores identifiers for users in the community exchange system. The username field 204 stores names of the users in the community exchange system. The user contact info field 206 stores contact information of the users in the community exchange system. The account balance field 208 stores the account balance of the users from their exchange activities in the community exchange system. The accumulated credit transaction field 210 stores the accumulated credit transaction points gained by the users for selling goods and services in the community exchange system. The accumulated debit transaction field 212 stores the accumulated debit transaction points debited to the user's account for buying goods and services in the community exchange system. The accumulated credit & debit transaction field 214 stores the accumulated credit and debit transaction points, which is the sum of the accumulated credit transaction and the accumulated debit transaction with the negative sign in the debit being ignored. The account balance is the net results of the accumulated credit transaction and the accumulated debit transaction in the user's account.

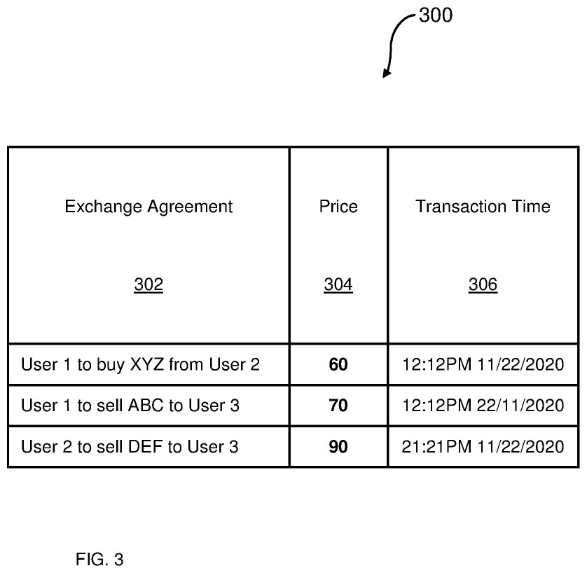

Referring to FIG. 3, as an example of the exchange agreement database 116 of FIG. 1, a tabular data 300 of exchange agreements between the users is illustrated. The exchange agreement field 302 lists buy and/or sell agreements between the users in the online community exchange system. The price field 304 stores price information of the exchange agreements. The transaction time field stores the time, on which the exchange agreements are scheduled to be carried out. For example, on the row two of the table 300, user 1 agrees to buy XYZ from user 2 at a price of 60 points to be carried out on or before 12:12 PM of Nov. 22, 2020.

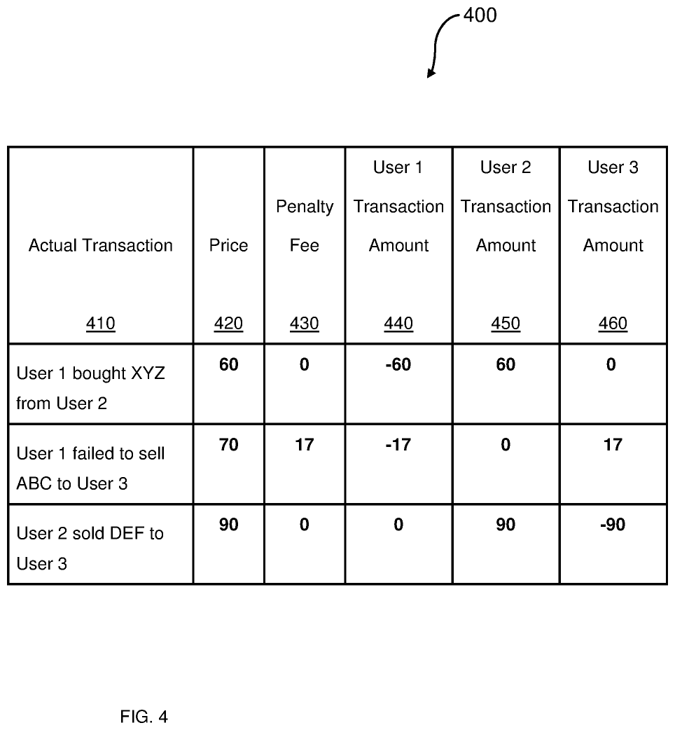

Referring to FIG. 4, as an example of the actual transaction database 118 of FIG. 1, a tabular transaction data 400 is illustrated, which also shows how a penalty fee is imposed to improve accountability in the exchange system. The actual transaction field 410 records whether exchange agreements are carried out successfully or not. The price field 420 stores the price information of the exchange agreements. The penalty fee field 430 records penalty fee charged to a user who fails to carry out an exchange agreement. The user 1 transaction amount field 440 stores the amount of credit or debit received from each transaction for user 1; the user 2 transaction amount field 450 stores the amount of credit or debit received from each transaction for user 2; and the user 3 transaction amount field 460 stores the amount of credit or debit received from each transaction for user 3. The amount of credit or debit also includes the penalty fee or compensation from failed transactions.

For example, on row three in the table 400, it shows that user 1 failed to carry out an exchange agreement with user 3. A penalty fee of 17 points is charged on user 1; and user 3, as the counterparty in the agreement, is credited with the same amount of points as the penalty fee. In the table 400, the penalty fee is set as a fixed 10 points plus 10% of the price of the exchange agreement. Once the penalty fee is set, as a rule, it is imposed on all users in the community exchange system. Any user who fails to carry out an exchange agreement will be charged with the penalty fee and the counterparty of the exchange agreement will be compensated with the same amount of points as the penalty fee.

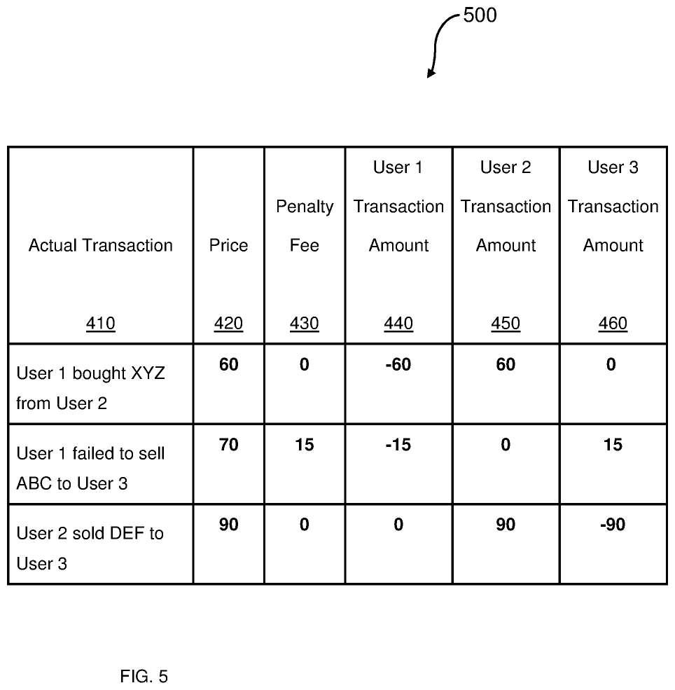

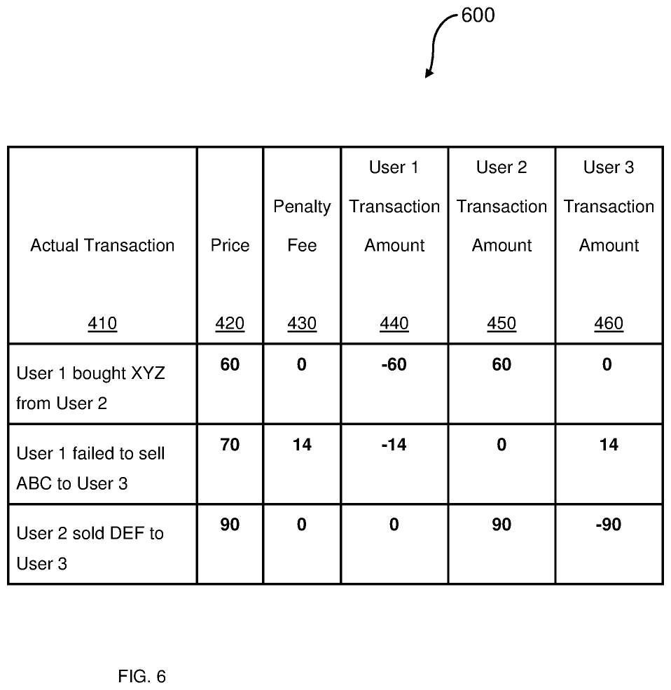

The penalty fee can be set in a different way. Referring to FIG. 5, the table 500 is the same as the table 400 of FIG. 4 except the penalty fee is set to be a fixed amount of 15 points. And in another example shown in FIG. 6, the table 600 again is the same as the table 400 of FIG. 4 except the penalty fee here is set as 20% of the price of the exchange agreement.

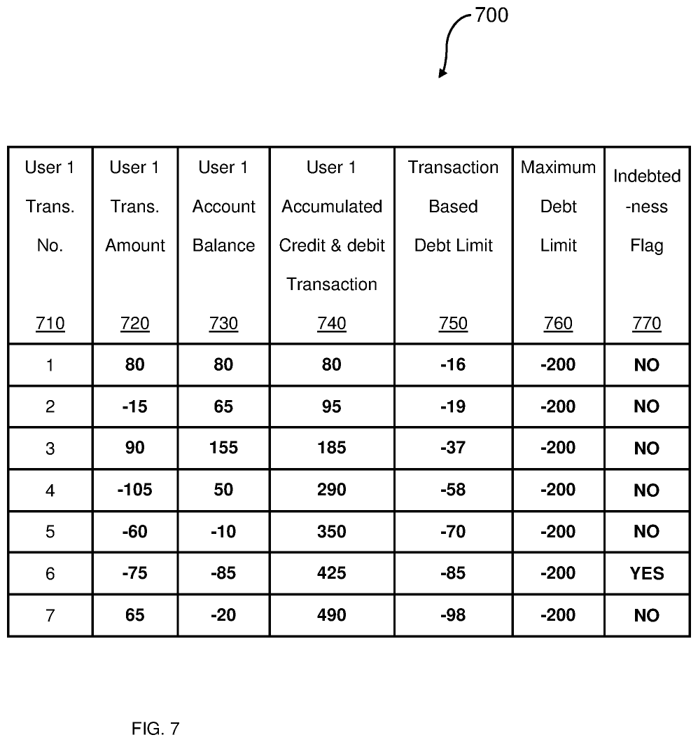

It is well known that in order to prevent some users from going too much deep in debt and abusing the community exchange system, a debt limit should be imposed in the exchange system. To further improve the trustworthiness of the exchange system, a method of imposing two debt limits is disclosed in this invention. Referring to FIG. 7, it is illustrated in the table 700 that a maximum debt limit and a transaction-based debt limit are imposed on users in the exchange system. The user 1 trans. No. field 710 lists the transaction numbers of the exchange agreements carried out in the user's exchange account. The user 1 trans. amount field 720 lists the amount of credit or debit received by user 1 from the transactions, wherein the credit is recorded as positive number and the debit as negative number. The user 1 account balance field 730 lists the user's account balance after each transaction; and the user 1 accumulated credit & debit transaction field 740 lists the user's accumulated credit and debit transaction points after each transaction. For example, at transaction No. 2, the accumulated credit & debit transaction is 95 points by adding a credit of 80 points from transaction No. 1 and a debit of 15 points from transaction No. 2, wherein the negative sign of the debit number is ignored. The transaction-based debt limit field 750 lists a changing transaction-based debt limit after each transaction; it is set as 20% of the accumulated credit & debit transaction. The maximum debt limit field 760 lists a maximum debt limit for all users in the exchange system; in the field 760, a maximum debt limit of 200 points is chosen as an example. The indebtedness flag field 770 lists indebtedness status for user 1 after each transaction. A negative account balance in the field 730 indicates the account in debt. When the debt in the user's account is less than both the two debt limits, the indebtedness flag is marked as “NO”. When the debt in the user's account has passed either the transaction-based debt limit or the maximum debt limit, the flag is raised to “YES”. When the flag is raised to “YES”, the user is restricted from doing debit transaction, i.e. buying goods & services, thereafter. The user could gain credit points and clear the flag by selling goods & services in the exchange system.

As shown in the table 700, the user's account balance at the field 730 is positive from transaction No. 1 to No. 4, therefore the indebtedness flag 770 is not raised. At transaction No. 5, the user's account goes negative thus in debt, but has not passed either of the two debt limits; the flag stays at “NO”. However, at transaction No. 6, user 1 does a debit transaction that causes the account balance to reach the transaction-based debt limit (−85 points); the indebtedness flag is therefore raised to “YES” and the user is restricted from doing debit transaction thereafter. Then, at transaction No. 7, the user does a credit transaction that brings down the debt level to −20 points, and the indebtedness flag is changed back to “NO”.

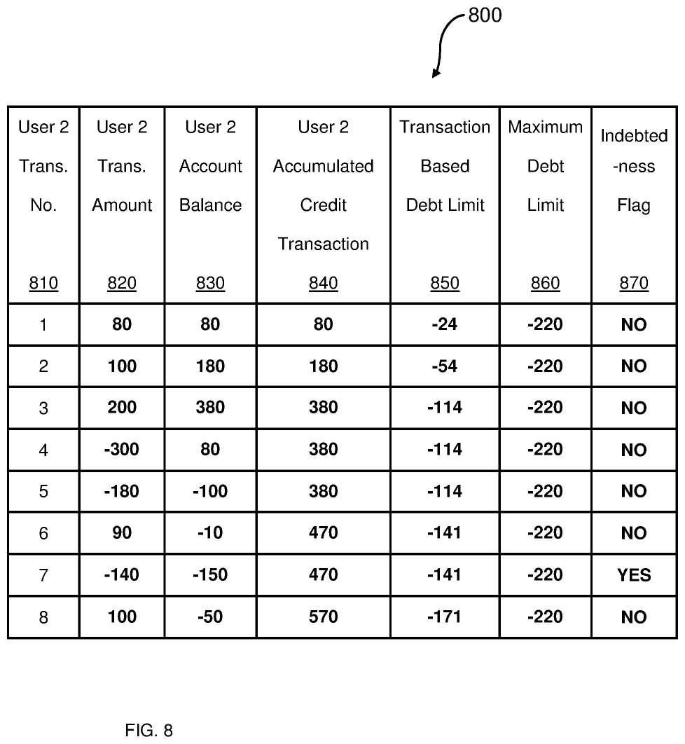

As another choice, the transaction-based debt limit can be based on accumulated credit transaction. Referring to FIG. 8, an example is illustrated in the table 800, in which a maximum debt limit and a transaction-based debt limit are imposed on users in the exchange system. The user 2 trans. No. field 810 lists the transaction numbers of the exchange agreements carried out in the user's exchange account. The user 2 trans. amount field 820 lists the amount of credit or debit received by user 2 from the transactions; the user 2 account balance field 830 lists the user's account balance after each transaction; and the user 2 accumulated credit transaction field 840 lists the user's accumulated credit transaction after each transaction. The transaction-based debt limit field 850 lists a changing transaction-based debt limit after each transaction; it is set as 30% of the accumulated credit transaction in the user's account. The maximum debt limit field 860 lists a maximum debt limit for all users; in the field 860, a maximum debt limit of 220 points is chosen as an example. The indebtedness flag field 870 lists indebtedness status for the user after each transaction. A negative account balance in the field 830 indicates the account in debt. When the debt in the user's account is less than both the two debt limits, the indebtedness flag is marked as “NO”. When the debt in the user's account has passed either the transaction-based debt limit or the maximum debt limit, the flag is raised to “YES”. When the flag is raised to “YES”, the user is restricted from doing debit transaction. The user could gain credit points and clear the flag by selling goods and services in the exchange system.

As shown in the table 800, the user's account balance at the field 830 is positive from transaction No. 1 to No. 4, therefore the indebtedness flag 870 is not raised. From transaction No. 5 to No. 6, the user's account is in debt, but the debt has not passed either of the two debt limits; the flag stays at “NO”. However, at transaction No. 7, although the user's account debt level (−150 points) is still below the maximum debt limit, it has passed the transaction-based debt limit (−141 points), so the indebtedness flag is raised to “YES” and the user is restricted from doing debit transaction thereafter. Then, at transaction No. 8, the user does a credit transaction that brings down the debt level to −50 points, and the indebtedness flag is changed back to “NO”.

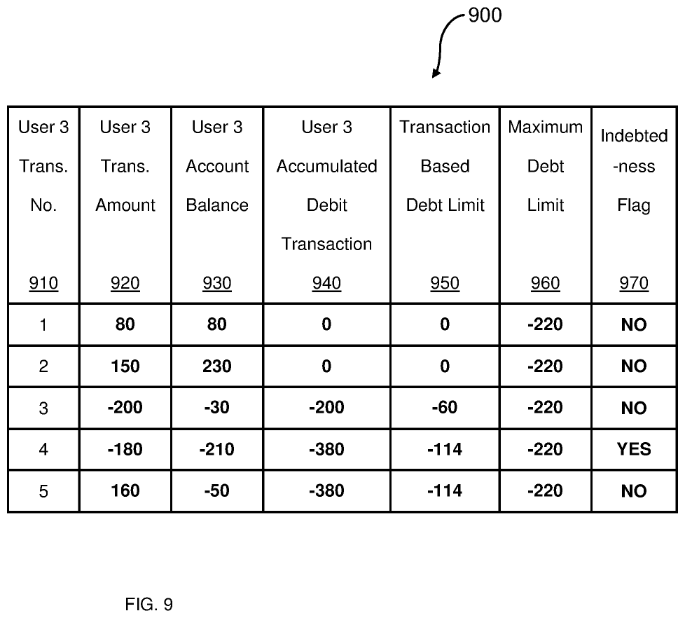

The transaction-based debt limit also can be based on accumulated debit transaction. Although seemingly counterintuitive, it still works because in the long run the two debt limits rule will force users to keep their debit and credit transactions in balance. Referring to FIG. 9, it is illustrated in the table 900 that a maximum debt limit and a transaction-based debt limit are imposed on users in the exchange system. The user 3 trans. No. field 910 lists the transaction numbers of the exchange agreements carried out in the user's account. The user 3 trans. amount field 920 lists the amount of credit or debit received by the user from the transactions; the user 3 account balance field 930 lists the user's account balance after each transaction; and the user 3 accumulated debit transaction field 940 lists the user's accumulated debit transaction after each transaction. The transaction-based debt limit field 950 lists a changing transaction-based debt limit after each transaction; and it is set as 30% of the user's accumulated debit transaction. The maximum debt limit field 960 lists a maximum debt limit for all users in the exchange system; in the field 960, a maximum debt limit of 220 points is chosen as an example. The indebtedness flag field 970 lists indebtedness status for the user after each transaction. A negative account balance in the field 930 indicates the account in debt. When the debt in the user's account is less than both the two debt limits, the indebtedness flag is marked as “NO”. When the debt in the user's account has passed either the transaction-based debt limit or the maximum debt limit, the flag is raised to “YES”. When the flag is raised to “YES”, the user is restricted from doing debit transaction. The user could gain credit points and clear the flag by selling goods and services in the exchange system.

As shown in the table 900, the user's account balance in the field 930 is positive from transaction No. 1 to No. 2, therefore the indebtedness flag 970 is not raised. At transaction No. 3, the user's account goes in debt, but the debt has not passed either of the two debt limits; the flag stays at “NO”. However, at transaction No. 4, user 3 does a debit transaction that causes the debt in the account to pass the transaction-based debt limit (−114 points); the indebtedness flag is therefore raised to “YES” and the user is restricted from doing debit transaction thereafter. Then, at transaction No. 5, the user does a credit transaction that brings down the debt level, and the indebtedness flag is changed back to “NO”.

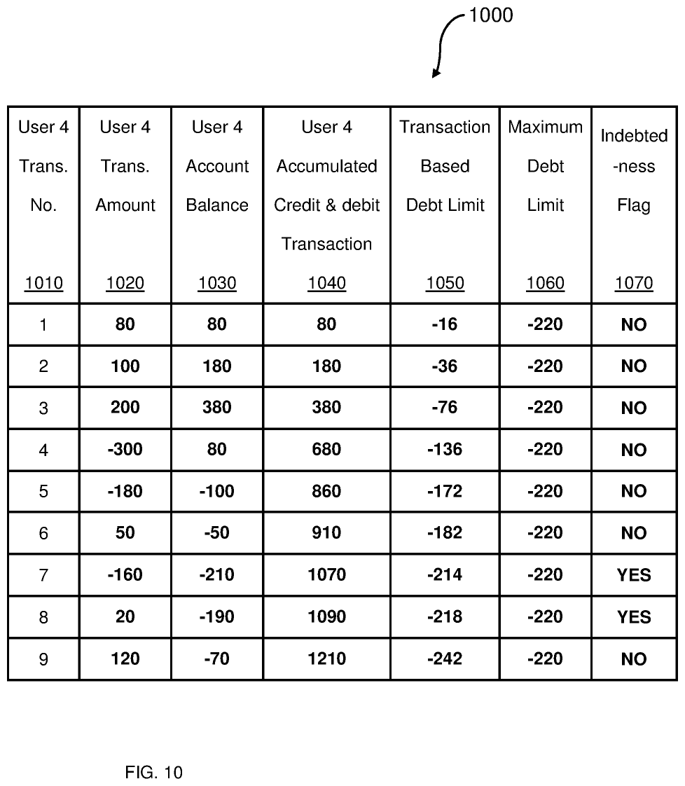

The two debt limits also can be imposed in a slightly different way; the indebtedness flag can be triggered when the debt level is too close to the two limits, even before crossing the limits. Referring to FIG. 10, in the table 1000, a maximum debt limit and a transaction-based debt limit are imposed on users in the exchange system. The user 4 trans. No. field 1010 lists the transaction numbers of the exchange agreements carried out in the user's exchange account. The user 4 trans. amount field 1020 lists the amount of credit or debit received by user 4 from the transactions; the user 4 account balance field 1030 lists the user's account balance after each transaction; and the user 4 accumulated credit & debit transaction field 1040 lists the user's accumulated credit and debit transaction after each transaction. The transaction-based debt limit field 1050 lists a changing transaction-based debt limit after each transaction; it is set as 20% of the user's accumulated credit & debit transaction. The maximum debt limit field 1060 lists a maximum debt limit for all users; in the field 1060, a maximum debt limit of 220 points is chosen as an example. The indebtedness flag field 1070 lists indebtedness status for the user after each transaction. A negative account balance in the field 1030 indicates the account in debt. When the debt in the user's account is less than both the two debt limits, the indebtedness flag is marked as “NO”. When the debt in the user's account has passed either the transaction-based debt limit or the maximum debt limit, the flag is raised to “YES”. Also, the flag is raised to “YES” if the debt in the account reaches a level that is a fraction of the average transaction size points from either one of the two debt limits. When the flag is raised to “YES”, the user is restricted from buying goods and services in the exchange system. The user could gain credit points and clear the flag by selling goods and services in the exchange system.

As shown in the table 1000, the user's account balance at the field 1030 is positive from transaction No. 1 to No. 4, therefore the indebtedness flag 1070 is not raised. From transaction No. 5 to No. 6, the user's account goes in debt, but has not passed either of the two debt limits and is with sizeable points away from both the two limits; the flag stays at “NO”. However, at transaction No. 7, the debt in the user's account is so high (−210 points), less than 3% of the average transaction size, which is about 153 points at No. 7, from the transaction-based debt limit (−214 points), that a potentially small debit transaction would cause the debt level to pass the debt limit, so the indebtedness flag is raised to “YES” and the user is restricted from doing debit transaction, i.e. buying goods and services, thereafter. And at transaction No. 8, the user does a small credit transaction and brings the debt level down to −190 points, which however is still very close to the transaction-based debt limit of −218 points. That is 28 points away from the limit, less than 21% of the average transaction size (136 points at the time), therefore the indebtedness flag remains at “YES”. Then, next at transaction No. 9, the user does another credit transaction that brings the debt level down by sizeable points, and the indebtedness flag is changed to “NO”.

In the above description on FIG. 10, the accumulated credit & debit transaction is used only as an example; it can be replaced with either the accumulated credit transaction or the accumulated debit transaction in the user's exchange account and the method works too.

The invention has been described in preferred forms and methods by way of examples. It will be understood by those skilled in the art that various changes and modifications may be made to the embodiments without departing from the spirit or scope of the invention. It is not intended that the invention be limited in any way to the embodiments shown and described herein and it is intended that the invention be limited only by the claims appended hereto.

What is claimed is:

1. A method for imposing a penalty rule on a plurality of users in an online community exchange system, wherein goods and services are exchanged among said a plurality of users with the use of local currencies such as a local digital currency, comprising:
setting a penalty fee for failing to carry out exchange agreements in said online community exchange system;
charging said penalty fee to a user who fails to carry out an exchange agreement; and
crediting the other user, who is the counterparty of said exchange agreement, with the same amount as said penalty fee.

2. The method of claim 1, wherein said penalty fee is a fixed amount.

3. The method of claim 1, wherein said penalty fee is a fraction of the price of said exchange agreement.

4. The method of claim 1, wherein said penalty fee is a fixed amount plus a fraction of the price of said exchange agreement.

5. A method for imposing two debt limits in an online community exchange system, wherein goods and services are exchanged among a plurality of users with the use of local currencies such as a local digital currency, comprising:
setting a maximum debt limit to said a plurality of users in said online community exchange system;
setting a transaction-based debt limit to each user based on an accumulated transaction in said each user's exchange account;
imposing both said maximum debt limit and said transaction-based debt limit on each of said a plurality of users in said online community exchange system;
raising an indebtedness flag to a user whose debt has passed either said maximum debt limit or said transaction-based debt limit; and
restricting said indebtedness-flagged user from buying goods and services in said online community exchange system.

6. The method of claim 5, wherein said transaction-based debt limit for each user is set as a fraction of the accumulated credit & debit transaction in said each user's exchange account.

7. The method of claim 5, wherein said transaction-based debt limit for each user is set as a fraction of the accumulated credit transaction in said each user's exchange account.

8. The method of claim 5, wherein said transaction-based debt limit for each user is set as a fraction of the accumulated debit transaction in said each user's exchange account.

9. A method for imposing two debt limits in an online community exchange system, wherein goods and services are exchanged among a plurality of users with the use of local currencies such as a local digital currency, comprising:
setting a maximum debt limit to said a plurality of users in said online community exchange system;
setting a transaction-based debt limit to each user based on an accumulated transaction in said each user's exchange account;
imposing both said maximum debt limit and said transaction-based debt limit on each of said a plurality of users in said online community exchange system;
raising an indebtedness flag to a user whose debt has reached a level that is a fraction of the average transaction size points from either one of the two debt limits; and
restricting said indebtedness-flagged user from buying goods and services in said online community exchange system.

10. The method of claim 9, wherein said transaction-based debt limit for each user is set as a fraction of the accumulated credit & debit transaction in said each user's exchange account.

11. The method of claim 9, wherein said transaction-based debt limit for each user is set as a fraction of the accumulated credit transaction in said each user's exchange account.

12. The method of claim 9, wherein said transaction-based debt limit for each user is set as a fraction of the accumulated debit transaction in said each user's exchange account.
